(19) United States
(12) Patent Application Publication
(10) Pub. No.: US 2016/0070445 A1
(43) Pub. Date: Mar. 10, 2016

(54) DISPLAY SYSTEM AND DISPLAY PROGRAM

(71) Applicant: SEIKO EPSON CORPORATION, Tokyo (JP)

(72) Inventor: Isao SAKAMAKI, Matsumoto (JP)

(21) Appl. No.: 14/843,116

(22) Filed: Sep. 2, 2015

(30) Foreign Application Priority Data
Sep. 8, 2014 (JP) 2014-182017

(51) Int. Cl. G06F 3/0484; G06F 3/0488

(52) U.S. Cl. CPC G06F 3/04842; G06F 3/0488

(57) ABSTRACT

A display system includes a touch display, and a control unit that displays content on the touch display so as to follow movement of an operator. When it is detected that the operator is moving in a first direction, the control unit moves the content to follow the movement of the operator so that a fourth region of the content is displayed, in a first case in which a third region of the content is being displayed, and the control unit moves the content to follow the movement of the operator so that a first region including a first end of the content and a second region including a second end of the content are displayed, in a second case in which the first region is being displayed. A follow amount in the first case differs from a follow amount in the second case.

### CROSS REFERENCES TO RELATED APPLICATIONS

The entire disclosure of Japanese Patent Application No. 2014-182017, filed Sep. 8, 2014 is incorporated by reference herein.

### BACKGROUND

1. Technical Field

The present invention relates to a display system and a display program.

2. Related Art

Display systems that display content on a touch panel so as to follow an operator that touches the touch panel, are known. In addition, a technique that performs a looped display according to the operation of a list with a large number of items, is known.

JP-A-2012-137821 and Japanese Patent No. 4743919 are examples of the related art.

### SUMMARY

In this instance, a looped display refers to displaying, for example, a leading end side of content on a screen and causing the leading end side of the content to follow a tail end of the content if an operation that moves the tail end of the content in an inner side direction of the content is performed when the tail end of the content is displayed. However, in a looped display, there is a problem in that the ends of content are difficult for a user to identify.

An advantage of some aspects of the invention is to realize a looped display in which the ends of content are easy to identify.

According to an aspect of the invention, a display system includes a touch display and a control unit. The touch display is configured to display a content and to detect a movement of an operator, the content including a first region with a first end of the content, a second region with a second end of the content, a third region and a fourth region disposed between the first region and the second region. The control unit is configured to control displaying of the content on the touch display based on the movement of the operator detected by the touch display. When the touch display detects that the operator is moving in a first direction with respect to the touch display, the control unit is configured to: move the content displayed on the touch display to follow the movement of the operator so that the fourth region of the content is displayed on the touch display, in a first case in which the third region of the content is being displayed on the touch display when the operator starts moving in the first direction; and move the content displayed on the touch display to follow the movement of the operator so that the second region and the first region of the content are displayed on the touch display, in a second case in which the second region is being displayed when the operator starts moving in the first direction. A follow amount in the first case differs from a follow amount in the second case.

### BRIEF DESCRIPTION OF THE DRAWINGS

The invention will be described with reference to the accompanying drawings, wherein like numbers reference like elements.

FIGS. 1A to 1D are screen transition drawings that show an embodiment of the invention.

FIGS. 2A and 2B are screen transition drawings that show the embodiment of the invention.

FIGS. 3A and 3B are schematic diagrams that show the embodiment of the invention.

FIG. 4 is a flowchart illustrating an algorithm for a looped display process according to the embodiment of the invention.

FIG. 5 is a flowchart illustrating an algorithm for a replacement process according to the embodiment of the invention.

FIG. 6 is a graph that shows a relationship between a displacement of the content and a displacement of the operator according to the embodiment of the invention.

FIG. 7 is a graph that shows a relationship between a displacement of the content and a displacement of the operator according to the embodiment of the invention.

FIGS. 8A to 8D are screen transition drawings according to the embodiment of the invention.

FIGS. 9A and 9B are graphs that show a modified embodiment of the invention.

### DESCRIPTION OF EXEMPLARY EMBODIMENTS

Hereinafter, embodiments of the invention will be described with reference to the appended drawings. Additionally, in each figure, the same symbols are given to corresponding constituent elements, and overlapping descriptions are omitted.

According to the embodiment, there is provided a display system including a touch display, and a control unit that displays content on the touch display so as to follow movement of an operator that is detected by the touch display, in which the control unit displays a second end of the content of an opposite side to a first end in a first period, in which the operator moves exceeding a predetermined first distance from a position at which the first end of the content is presented in step with movement of the operator, displays a second end side of the content and does not display a first end side of the content in a case in which the operator becomes separated from the touch display in the first period, and displays a first end side of the content and does not display a second end side of the content in a case in which the operator has become separated from the touch display in a second period, in which the operator moves less than or equal to the first distance from a position at which the first end is presented, during movement of the operator.

According to this embodiment, in a case in which the operator becomes separated from the touch display in the period in which the second end of the content is displayed, as a result of switching between whether to display the first end side of the content and whether to display the second end side of the content depending on a movement distance of an operator after the second end is presented, a looped display in which the ends of content are easy to identify is realized. In this instance, the description that the operator becomes separated from the touch panel does not only include a circumstance in which the operator changes from a state of coming into contact with the touch display to a non-contact state, but also includes a circumstance in which a distance is increased in a non-contact state of the touch display and the operator in a case in which the touch display can detect an operator in the vicinity of the touch display.

### 1. Overview

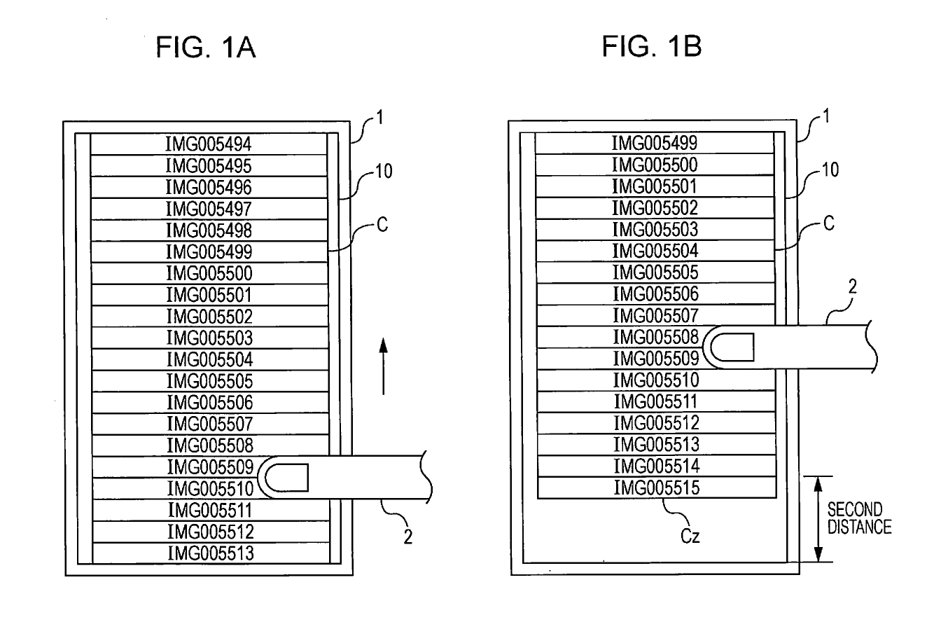

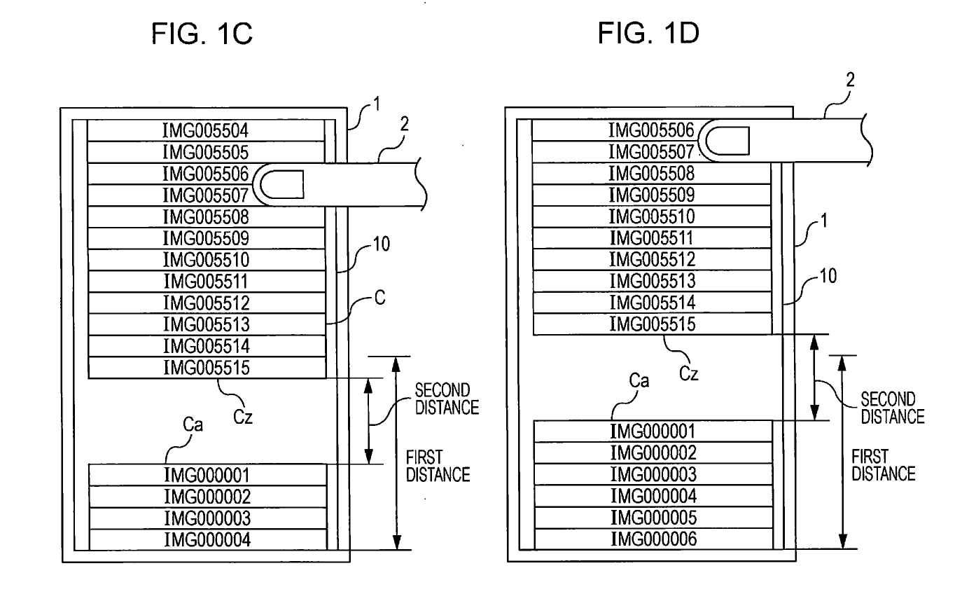

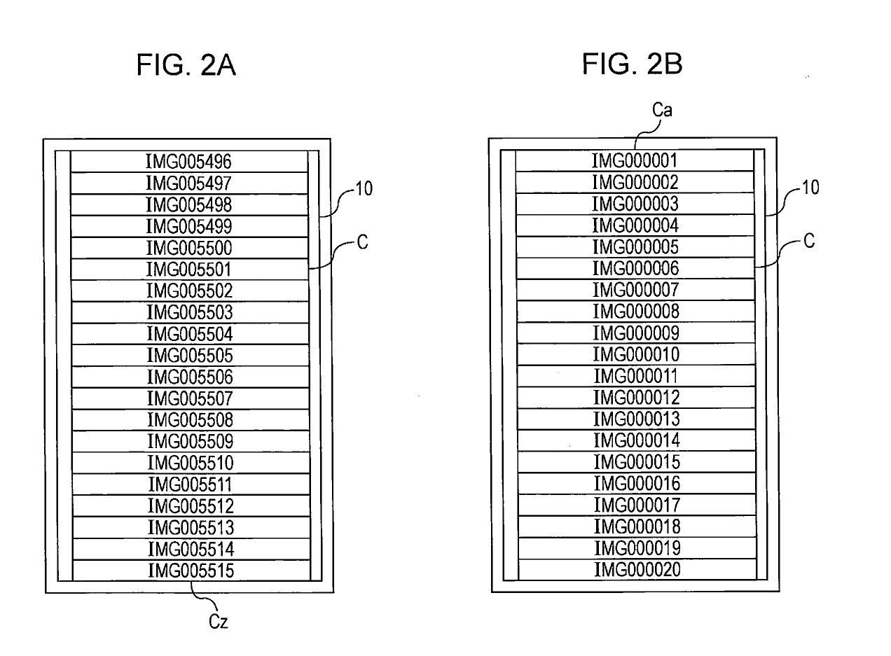

FIGS. 1A to 2B show screen transitions of a GUI that uses a display system 1 as an embodiment of the invention. As shown in FIGS. 1A to 1D, the display system 1 displays a content C so as to follow movement of a finger 2 (one example of an operator) that is detected by the touch panel 10. For example, as shown in FIG. 1A, in a state in which an intermediate section of content C on the touch panel 10 is being displayed, as a result of touching a display region of the content C of the touch panel 10 with the finger 2, and moving the finger 2 that touched the touch panel 10 in an inner side direction (the up direction in FIG. 1A) of the content C, a lower end or tail end Cz of the content C is displayed on the screen as shown in FIG. 1B. It is assumed that the finger 2 is separated from the touch panel 10 after the lower end or tail end Cz of the content C is displayed on the screen. In this case, the display system 1 switches between returning to a state in which the lower end Cz of the content C is displayed at a lower screen end as shown in FIG. 2A, and setting a state in which an upper end or leading end Ca of the content C of an opposite side to the lower end Cz is displayed at an upper screen end as shown in FIG. 2B depending on a movement distance of the finger 2 up to the point separating from the touch panel 10.

### 2. Configuration

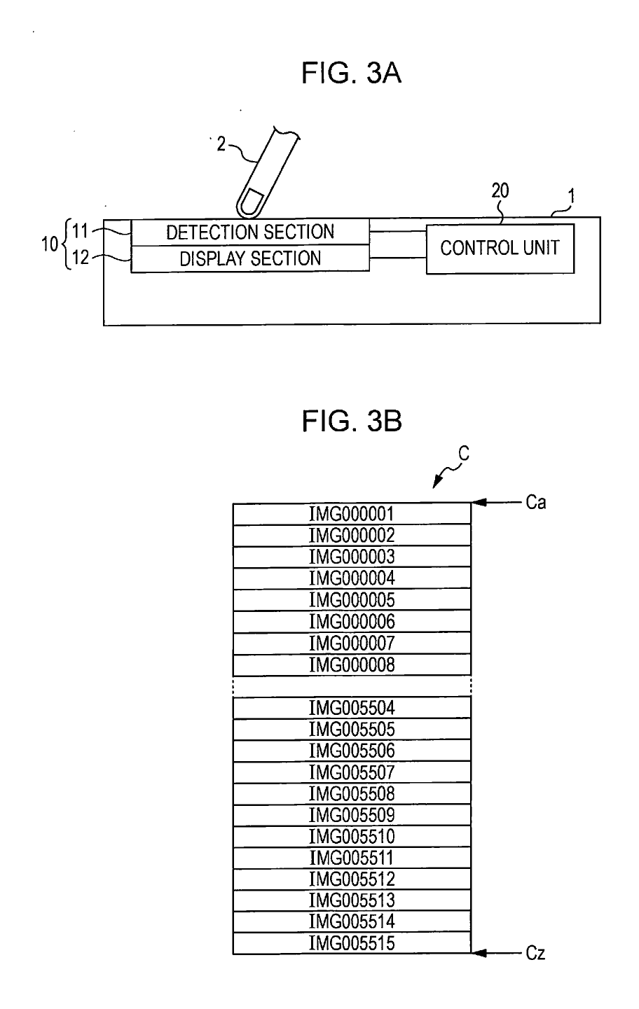

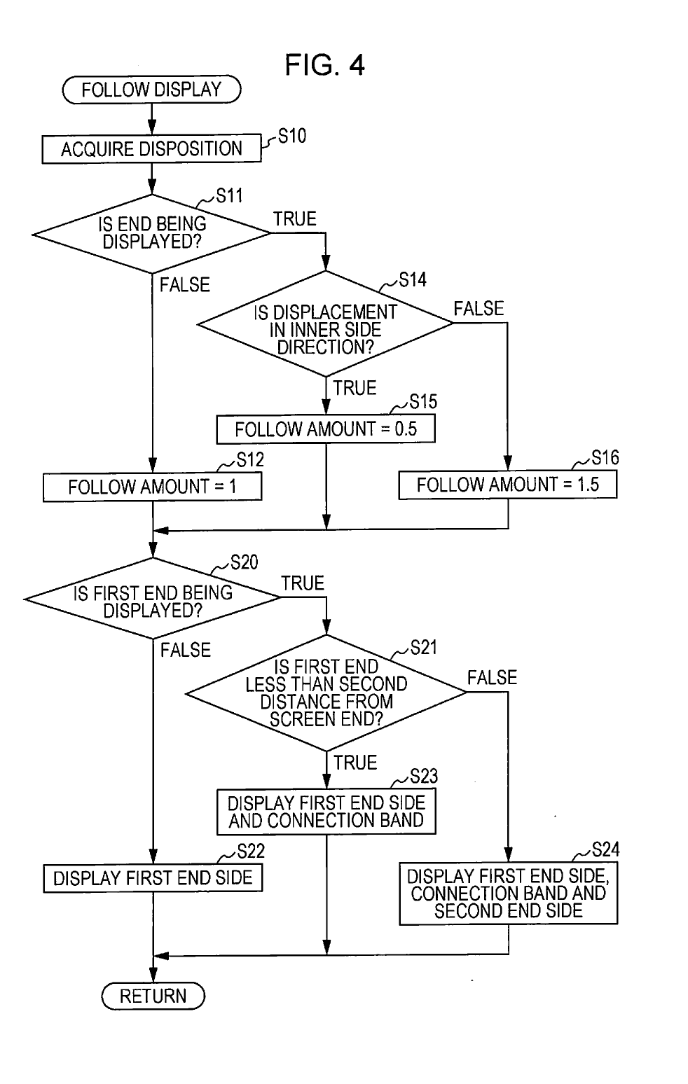

FIG. 3A is a block diagram that shows a configuration of the display system 1. The display system 1 may be a printer, a scanner, a Personal Digital Assistant (PDA), a car navigation system, an automated teller machine, a ticket-vending machine or the like that is provided with the touch panel 10 and a control unit 20. The touch panel 10 is a kind of touch display that recognizes operations of the finger 2, a touch pen or the like, and is provided with a function of displaying images, and a function of detecting where on a displayed image, which is a target object, an operator is pointing to. The touch panel 10 is provided with a detection section 11, which detects a contact position with an operator, and a display section 12, which displays images. The detection section 11 detects a contact position with an operator using a well-known method such as a resistance film method or an electrostatic capacitance method. The display section 12 is a well-known liquid crystal display, plasma display, organic EL display or the like. In addition, a configuration in which a method such as an infrared ray method that can recognize a position even in a state of not coming into contact with a screen, may be adopted as the detection section, and in which the position of an operator is detected even in a state of not coming into contact with a screen, may be used. The display section is not limited to one that performs display in 2D, and may be one that performs display in 3D. The control unit 20 is a computer that is provided with a processor, a main storage, an input-output mechanism and an external storage.

FIG. 3B is an example of content that the control unit 20 displays on the touch panel 10. The content C is an image that shows a list of selectable file names, and includes a character string, which shows a file name, and a rectangular line, which shows a selectable range that corresponds to each file name. In this example shown in FIG. 3B, the content C includes a first region with a leading end Ca (one example of a first end), a second region with a tail end Cz (one example of a second end), and third and fourth regions disposed between the first region and the second region. Since the display length from a leading end Ca to a tail end Cz in the content C is greater than a pixel number of the long side of the touch panel 10, it is not possible to display the entirety of the content C. Therefore, this becomes a target object of a looped display. The display length from the leading end Ca to the tail end Cz in the content C is a length (a pixel number) from the leading end Ca to the tail end Cz in the content C. For example, if the pixel number of the long side of the touch panel 10 is set to be 300 pixels, content C in which the distance length from leading end Ca to tail end Cz is longer than 300 pixels becomes a target object for looped display. The control unit 20 sets a target object display region that corresponds to a screen size of the touch panel 10 for the content C, and displays the target object display region of the content C on the touch panel 10. In addition, a case in which an operator comes into contact with and is immediately separated from the detection section 11 (a case in which a contact time is shorter than a time that was set in advance), is considered as the operator selecting a portion of the content that was displayed in a contacted location. In the present embodiment, such a case is set as an image file of a file name that was displayed in a position that the operator came into contact with, being selected, and display is performed by switching a screen to an image of the content of the corresponding image file.

### 3. Operation

FIG. 4 is a flowchart that shows a flow of a looped display process that is executed by a display program. The control unit 20 performs a looped display of the content C on the touch panel 10 in the following manner by executing a display program that is stored in the external storage. The looped display process activates when a contact position with an operator, which is output from the touch panel 10 changes in a state in which content, which is a target object of the looped display, is being displayed on the touch panel 10.

Firstly, the control unit 20 acquires a displacement of an operator on the basis of an output of the touch panel 10 (S10). More specifically, the control unit 20 acquires an amount of change and a change direction of the contact position between the touch panel 10 and the operator as the displacement of the operator. Hereinafter, the amount of change of the contact position between the touch panel 10 and the operator will be referred to as a movement distance of the operator, and the change direction of the contact position between the touch panel 10 and the operator will be referred to as a movement direction of the operator. Additionally, in the present embodiment, since the content C only moves in a long side direction of the touch panel 10, the control unit 20 detects either one of two directions that are parallel to the long side of the touch panel 10 as the movement direction of the operator. That is, in a case in which the operator moves in an arbitrary direction, only directional components of the displacement that are parallel to the long side of the touch panel 10 are acquired as the displacement of the operator.

Next, the control unit 20 determines whether or not the leading end Ca or the tail end Cz of the content C is being displayed on the touch panel 10 (S11). In a case in which neither the leading end Ca or the tail end Cz of the content C is being displayed, the control unit 20 sets a follow amount to 1 (S12). In this instance, a follow amount is set as a ratio of a movement distance within the screen of the content C to the movement distance of the operator. That is, in a case in which neither the leading end Ca or the tail end Cz of the content C is being displayed, the follow amount is set so that the movement distance and the movement direction of the content C coincide with the movement distance and the movement direction of the operator. As a result of this, in Step S22, the content C moves within the screen at a speed with which the operator moves in a long side direction of the screen.

In a case in which the leading end Ca or the tail end Cz of the content C is being displayed on the touch panel 10, the control unit 20 determines whether or not the displacement of the operator is in the inner side direction of the content C (S14). FIGS. 1B, 1C and 1D show states in which the tail end Cz of the content C is being displayed on the touch panel 10 as a first end. The inner side direction of the content C is a direction that runs toward an inner side of the content C on a selected side when viewed from an end of the content C on the side selected by the operator. In FIGS. 1B, 1C, and 1D, since the finger 2 selects a tail end Cz side of the content C and the tail end Cz corresponds to a lower end of the content C on a tail end side of the content C, the inner side direction of the content C is the up direction. That is, the inner side direction of the content C on a leading end Ca side of the content C that is shown in FIGS. 1C and 1D is a down direction, but since the tail end Cz side of the content C is selected by the finger 2, “a direction that runs toward an inner side of the selected content C when viewed from an end of the content C that is selected by the operator” is the same as that in FIG. 1B, and is a direction that runs from the bottom toward the top of the figure. Therefore, as shown in FIGS. 1B, 1C and 1D, in a case in which the content C is displayed and the finger 2, which is touching the touch panel 10, moves in a direction that runs from the bottom toward the top of the figure, it is determined that the displacement of the operator is in the inner side direction of the content C. In addition, as shown in FIGS. 1B, 1C and 1D, in a case in which the content C is displayed and the finger 2, which is touching the touch panel 10, moves in a direction that runs from the top toward the bottom of the figure, it is determined that the displacement of the operator is not in the inner side direction of the content C.

In a case in which the displacement of the operator is in the inner side direction of the content C in a state in which an end of the content C is being displayed, the control unit 20 sets the follow amount to 0.5 (S15). That is, in a case in which an end of the content C is being displayed and the displacement of the operator is in the inner side direction of the content C, the control unit 20 sets the follow amount so that the content C moves a distance of 0.5 times the movement distance of the operator in the movement direction of the operator. As a result of this, in a case in which the displacement of the operator is in the inner side direction, the content C moves within the screen more slowly than the finger 2 in Step S23 and Step S24.

In a case in which the displacement of the operator is not in the inner side direction of the content C, the control unit 20 sets the follow amount to 1.5 (S16). That is, in a case in which the displacement of the operator is in an outer side direction of the content C, the control unit 20 sets the follow amount so that the content C moves a distance of 1.5 times the movement distance of the operator in the movement direction of the operator. As a result of this, the content C moves within the screen more quickly than the operator in Step S23 and Step S24.

In this manner, as a result of setting the content C to move more slowly than the operator or to move more quickly than the operator in a state in which an end of the content C is being displayed, it is possible to give a user a sense that the end of the content C is stretched to the screen end, and pushed back from the screen end. The sense that the content C is stretched to and pushed back from the screen end occurs in a case in which a user moves the finger 2 on the screen in a state in which the end of the content C is being displayed, and since the sense that the content C is stretched to and pushed back from the screen end does not occur in a state in which the end of the content C is not being displayed, it is possible for a user to easily recognize that the end of the content C is being displayed. Additionally, a setting range of the follow amount that gives a user the sense that the end of the content C is stretched to the screen end is applicable as long as the range is greater than 0 and less than 1. In addition, a setting range of the follow amount that gives a user the sense that the end of the content C is pushed back from the screen end is applicable as long as the range is greater than 1.

Next, the control unit 20 determines whether or not the first end of the content C is being displayed (S20). In this instance, the first end is an end, among the two ends of the content C that is a target object of looped display, which is first presented on the screen with movement of the operator, the second end is an end of the content that is presented after the first end. For example, when the operator continues to move upward on the screen in a state in which neither of the ends of the content C is being displayed on the screen, if the content C is displayed so as to follow the operator, as shown in FIG. 1B, the tail end Cz of the content C is presented on the screen before the leading end Ca. Therefore, in this case, the first end is the tail end Cz of the content C and the second end is the leading end Ca of the content C. That is, in this case, if neither of the ends of the content C is being displayed on the screen, it is determined that the first end of the content C is not being displayed.

In a case in which the first end of the content C is not being displayed, the control unit 20 moves the content C by a movement distance of the operator and displays the content C on the touch panel 10 (S22). For example, as shown in FIG. 1A, when the finger 2 moves 200 pixels in the up direction in FIG. 1A in a state in which the content C is being displayed, the control unit 20 sets the follow amount to 1 in Step S12, and moves the content C 200 pixels in the up direction in FIG. 1A in Step S22.

In a case in which the first end of the content C is being displayed, the control unit 20 determines whether or not a distance from the first end to the screen end of the touch panel 10 on which the first end is presented is less than a predetermined second distance (S21).

In a case in which the distance from the first end to the screen end of the touch panel 10 on which the first end is presented is less than the second distance, the control unit 20 displays the content C on the touch panel 10 by following the operator with a follow amount of 0.5 (S23). For example, as shown in FIG. 1B, when the finger 2 moves 200 pixels in the up direction in FIG. 1B in a state in which the content C is being displayed, the control unit 20 moves the content C 100 pixels within the screen in the up direction in FIG. 1B. In this case, an image other than the content C which it is easy to recognize as different from the content C, is displayed in a blank space within the screen, which is generated as a result of the target object display region of the content C being reduced, as a connection band. More specifically, for example, a backdrop image of the content C may be displayed as the connection band, or an image other than a backdrop image which it is easy to recognize as a region that is different from the content C, may be displayed as the connection band.

In a case in which the distance from the first end to the screen end of the touch panel 10 on which the first end is presented is not less than the predetermined second distance, that is, in a case in which the distance from the first end to the screen end is greater than or equal to the predetermined second distance, the control unit 20 respectively sets the target object display region to the first end side and the second end side of the content C, and displays the first end side, the second end side and the connection band of the content C on a single screen (S24). The distance between the first end and the second end is, as shown in FIGS. 1C and 1D, set as the predetermined second distance, and the connection band is inserted between the first end and the second end. For example, as shown in FIG. 1C, when the finger 2 moves 100 pixels in the up direction in FIG. 1C in a state in which the first end Cz of the content C is separated from the screen end by greater than or equal to the second distance, the control unit 20 sets the follow amount to 0.5 in Step S16, and moves the content C 50 pixels in the up direction in FIG. 1C preserving a first end Cz side, a second end Ca side, and the second distance of the content C. In addition, for example, as shown in FIG. 1C, when the finger 2 moves 100 pixels in the down direction in FIG. 1C in a state in which the first end Cz of the content C is separated from the screen end by greater than or equal to the second distance, the control unit 20 sets the follow amount to 1.5 in Step S16, and moves the content C 150 pixels in the down direction in FIG. 1C preserving the first end Cz side, the second end Ca side, and the second distance of the content C.

After S22, S23, and S24, if a state in which the operator is touching the touch panel 10 continues, the process returns to S10 and is repeated. Meanwhile, if the operator is separated from the touch panel 10, the present process is completed, and a replacement process proceeds.

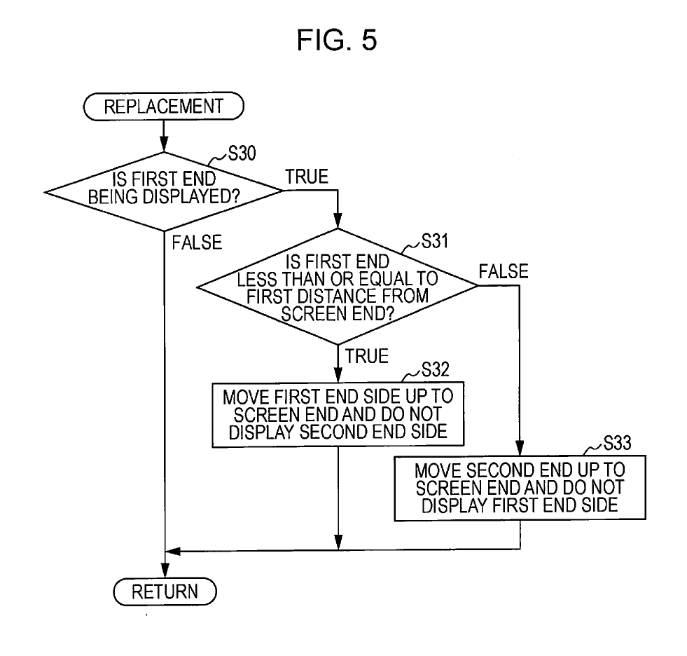

Next, a replacement process that replaces the target object display region of the content C, which is a target display object on the touch panel 10, will be described with reference to FIG. 5. The replacement process activates when the touch panel 10 detects that the operator has become separated therefrom in a state in which the content C is being displayed on the touch panel 10.

Firstly, the control unit 20 determines whether or not the first end of the content C is being displayed on the touch panel 10 (S30). In a case in which the first end of the content C is not being displayed on the touch panel 10, the control unit 20 completes the replacement process. In this case, even if the operator becomes separated from the touch panel 10, the content that is being displayed on the screen does not move.

In a case in which the first end of the content is being displayed on the touch panel 10, the control unit 20 determines whether or not a distance from the first end of the content C to the screen end on which the first end is presented is less than or equal to the predetermined first distance (S31). In this instance, the first distance is applicable as long as the distance is determined in advance to a range that exceeds the second distance.

In a case in which the distance from the first end of the content C to the screen end on which the first end is presented is less than or equal to the first distance, the control unit 20 moves the content within the screen so that the first end of the content C moves to the screen end on which the first end is presented (S32). Since the first distance is determined as a range that exceeds the second distance in advance, in a case in which the first end is in a range less than or equal to the first distance but exceeds the second distance, as shown in FIG. 1C, the operator is separated from the touch panel 10 in a state in which the first end side and the second end side of the content are displayed on the screen. In this case, as shown in FIG. 2A, the control unit 20 moves the first end of the content to the screen end on which the first end is presented, and does not display the second end side of the content C and the connection band. Thus, FIG. 2A shows an example of a first display mode in which the first region with the first end (the tail end Cz in this example) of the content is displayed and the second region with the second end (the leading end Ca in this example) is not displayed on the touch display.

In a case in which the distance from the first end of the content to the screen end on which the first end is presented exceeds the first distance, the control unit 20 moves the content within the screen so that the second end of the content moves to a screen end of an opposite side to the screen end on which the first end is presented, and so that the first end side of the content is not displayed (S33). More specifically, for example, as shown in FIG. 1D, if the finger 2 becomes separated from the touch panel 10 when the first end side and the second end side of the content C are being displayed, as shown in FIG. 2B, the control unit 20 moves the content C so that the second end Ca of the content C overlaps with a screen upper end of the touch panel 10, and does not display the first end side of the content C and the connection band. Thus, FIG. 2B shows an example of a second display mode in which the first region with the first end (the tail end Cz in this example) of the content is not displayed and the second region with the second end (the leading end Ca in this example) is displayed on the touch display.

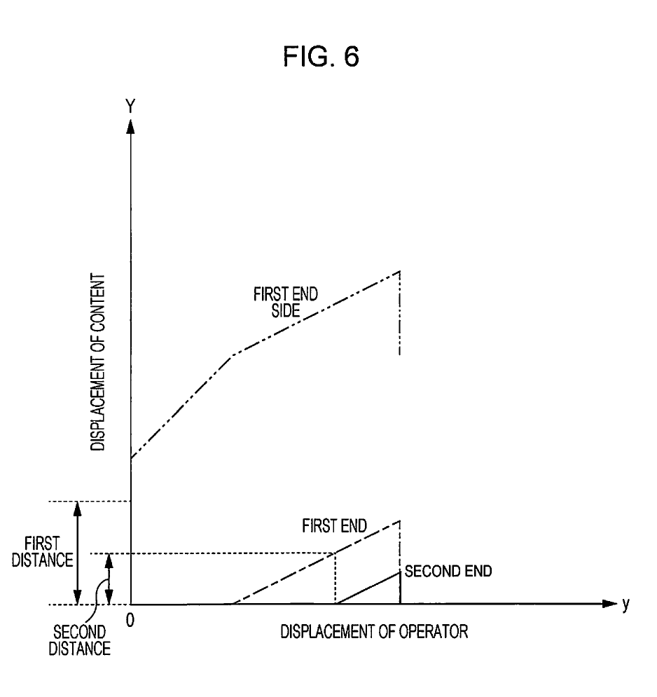

FIG. 6 is a graph that shows displacement of the finger 2 and the content in a case in which the finger 2 moves in the up direction after the finger 2 has touched the touch panel 10 in the state shown in FIG. 1A, and the finger 2 is separated from the touch panel 10 in the state shown in FIG. 1C. If the finger 2 moves in the up direction from the state that is shown in FIG. 1A, since the follow amount is set to 1 until the first end is presented on the screen, the content C moves in the up direction at the same speed as the finger 2 as shown by a two-dot chain line (the first end side) in FIG. 6. since the follow amount is set to 0.5 during a period in Which the finger 2 moves in the up direction after the first end of the content is presented at a lower end of the screen, the first end side of the content C moves in the up direction at a speed of 0.5 times that of the finger 2 as shown by a dashed-dotted line (the first end) and a two-dot chain line. If the first end of the content follows the finger 2 and moves a second distance in the up direction, the second end side of the content is presented on the screen as shown by a solid line (the second end), and if the finger 2 further moves in the up direction, the first end side and the second end side of the content moves in the up direction at a speed of 0.5 times that of the finger 2. If the finger 2 is separated from the touch panel 10 during a period in which the first end of the content follows the finger 2 and moves a range that exceeds the second distance but does not exceed the first distance in the up direction, the first end side of the content C moves in the down direction until reaching a lower end of a screen on which the first end and the second end are presented as shown by a dashed-dotted line and a two-dot chain line. In addition, at this time, the second end side of the content C moves until the second end reaches a lower end of a screen on which the first end and the second end are presented as shown by a solid line and is not displayed. As a result of this, as shown in FIG. 2A, only the tail end Cz of the content C is displayed on the touch panel 10.

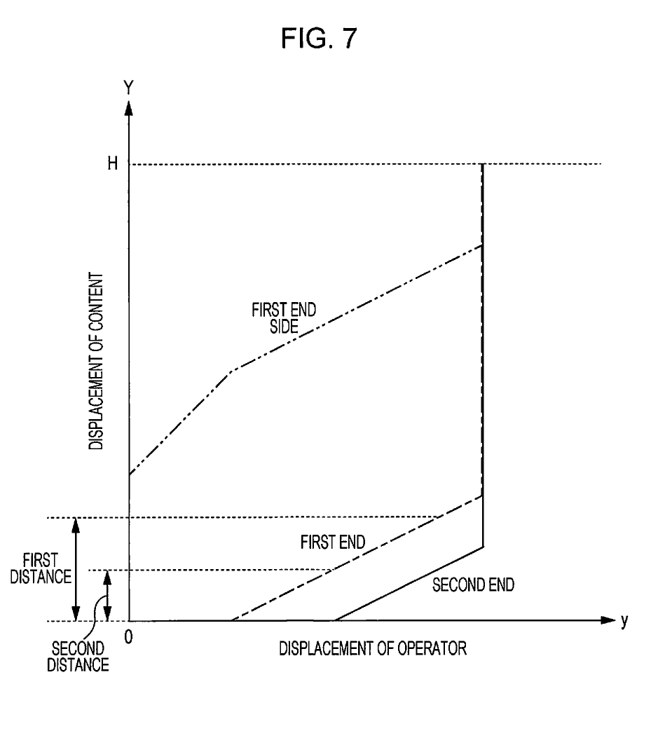

FIG. 7 is a graph that shows displacement of the finger 2 and the content in a case in which the finger 2 moves in the up direction after the finger 2 has touched the touch panel 10 in the state shown in FIG. 1A, and the finger 2 is separated from the touch panel 10 in the state shown in FIG. 1D. If the finger 2 moves in the up direction from the state that is shown in FIG. 1C, the content C follows the finger 2, and in the manner mentioned above, the first end and the second end are presented in order from the lower end of the screen. If the finger 2 is separated from the touch panel 10 during a period in which the first end of the content follows the finger 2 and moves exceeding the first distance in the up direction, as shown by a solid line, the second end side of the content C moves in the up direction until the second end reaches an upper end of the screen on an opposite side to the lower end of the screen on which the first end and the second end are presented (H represents a length of the screen in a long side direction). At this time, the first end side of the content C is not displayed when the first end reaches an upper end of the screen as shown by a dashed-dotted line. As a result of this, as shown in FIG. 2B, only the leading end side of the content C is displayed on the touch panel 10.

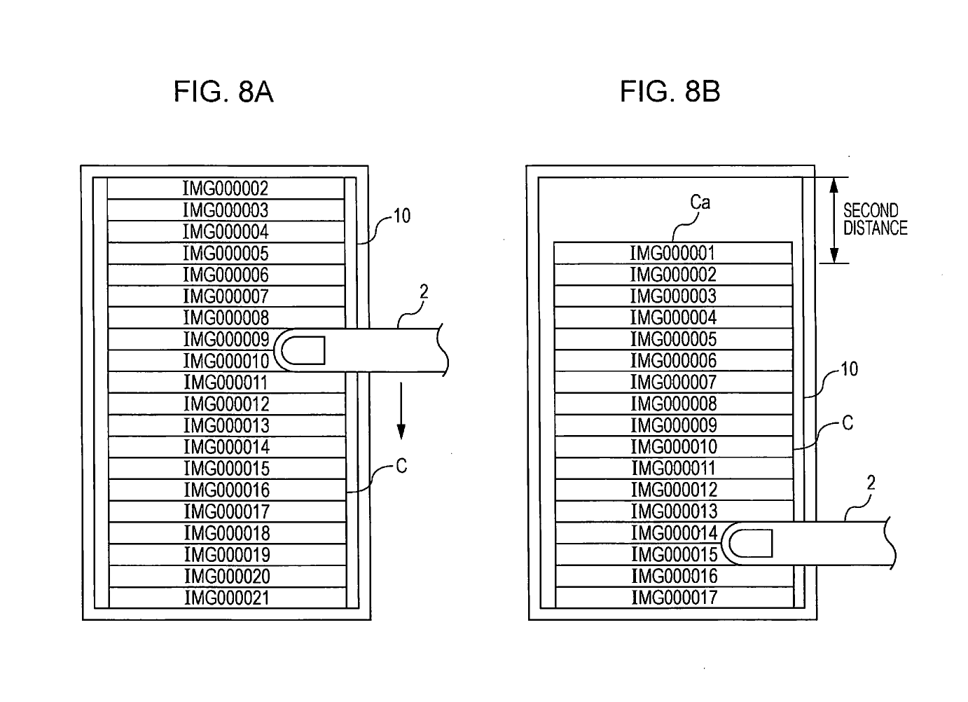

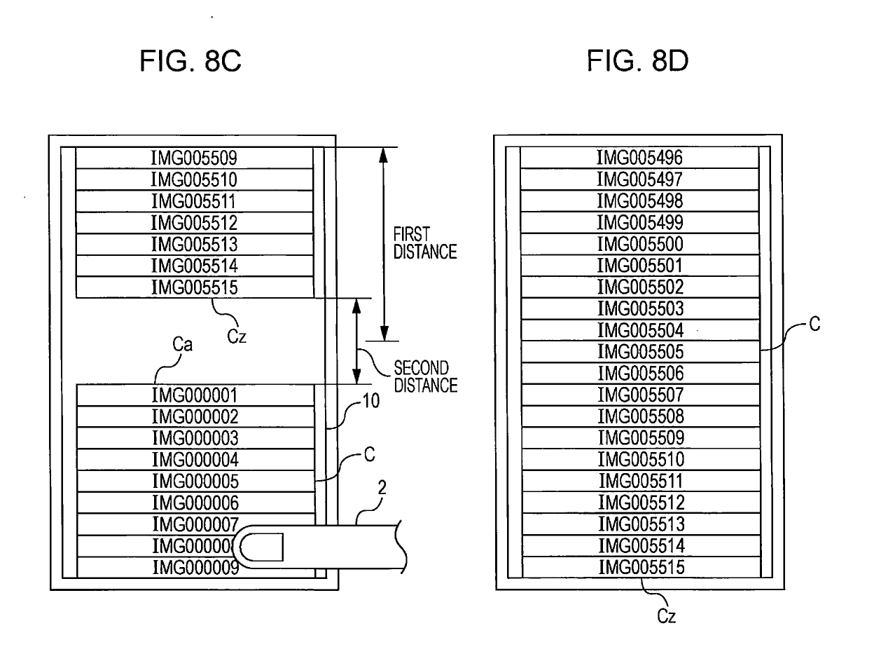

Additionally, in a case of executing the looped display and the replacement process that are described above, when the finger 2 moves in the down direction, the screen transitions as shown in FIGS. 8A to 8D. That is, if the finger 2 moves in the down direction after touching the touch panel 10 as shown in FIG. 8A, the leading end Ca of the content C is presented at the upper end of the screen as the first end as shown in FIG. 8B. If the finger 2 further moves in the down direction, after the tail end Cz of the content C is presented at the upper end of the screen as the second end, the tail end Cz moves in the down direction of the screen with the first end side and the second end side of the content C preserving the second distance as shown in FIG. 8C. As shown in FIG. 8C, if the finger 2 is separated from the touch panel 10 in a state in which the distance from the first end of the content C to the upper end of the screen on which the first end is presented exceeds the first distance, as shown in FIG. 8C, the content C moves in the down direction of the screen until the second end Cz reaches the lower end of the screen, and the first end side of the content C is not displayed.

In this manner, as a result of switching between displaying the first end side of the content and displaying the second end side of the content depending on the movement distance of the content after the first end of the content is displayed on the screen in a case in which the operator is separated from the touch panel 10 in a period in which the first end of the content is being displayed, a looped display in which the ends of content are easy to identify is realized.

### 4. Other Embodiments

The technical range of the invention is not limited to the abovementioned embodiment, and naturally, it is possible to add various modifications within a range that does not depart from the scope of the invention.

For example, a configuration that switches between a first display mode of displaying the first end side of the content and not displaying the second end side, and a second display mode of displaying the second end side of the content and not displaying the first end side depending on the movement distance of the operator after the first end of the content is presented may be used in place of the movement distance of the content after the first end of the content is presented, in a case in which the operator is separated from the touch panel 10 in a period in which the first end of the content is being displayed.

In addition, for example, a configuration that switches between the first display mode and the second display mode depending on the movement distance of the content or the operator after the first end of the content is presented in a period in which the first end of the content is being displayed regardless of whether or not the operator is separated from the touch panel 10, may be used. More specifically, in a case in which the operator moves in the inner side direction of the content exceeding a third distance (may be equivalent to the first distance, or may be longer than the first distance) after the first end is presented, even if the operator is touching the touch panel, only the second end side may be displayed by moving the content more quickly than the operator until the first end side is no longer displayed.

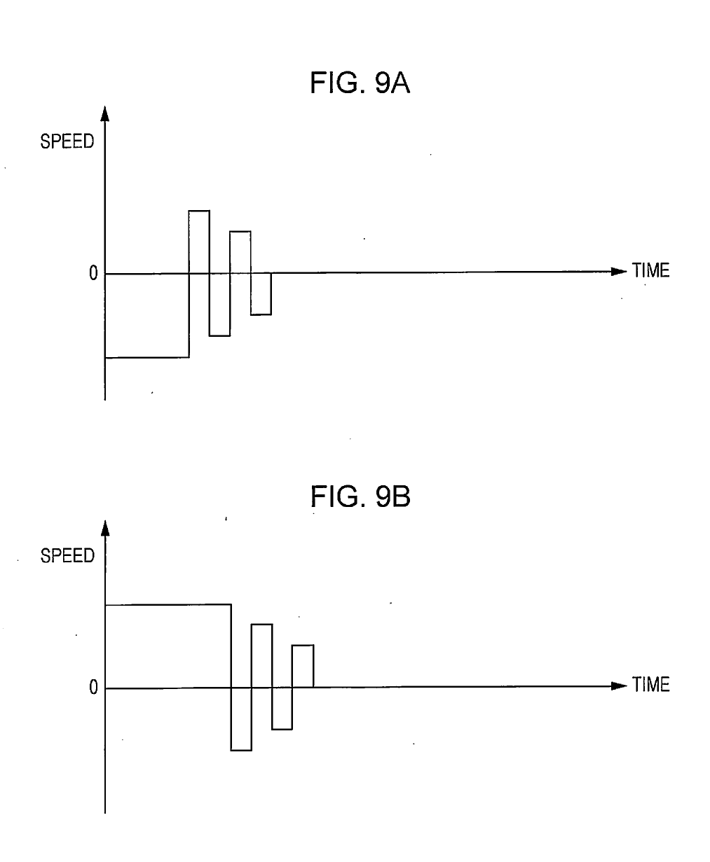

In addition, when the first end or the second end of the content C is moved to the screen end, the content C may be moved so that the end of the content C runs into the screen end and bounces against the screen end. For example, when the first end Cz of the content C is moved to the lower end of the screen in a case in which the finger 2 becomes separated from the touch panel 10 in the state shown in FIG. 1C, as shown in FIG. 9A, the speed of the content C vibrates. In the example that is shown in FIG. 9A, the first end Cz of the content C repeats an action of running into the lower end of the screen and bounces back twice, and becomes static at the lower end of the screen on the 3^{rd} fall. In addition, for example, when the second end Ca of the content C is moved to the upper end of the screen in a case in which the finger 2 becomes separated from the touch panel 10 in the state shown in FIG. 1D, as shown in FIG. 9B, the speed of the content C vibrates. In the example that is shown in FIG. 9B, the second end Ca of the content C repeats an action of rising to the upper end of the screen and bounces back twice, and becomes static at the upper end of the screen on the 3^{rd} rise. In FIGS. 9A and 9B, the positive speed indicates the content moves in the down direction and the negative speed indicates the content moves in the up direction. By moving the content C irrespective of the operator in this manner, it is easier for a user to recognize the ends of the content C.

In addition, a configuration may be used that moves the content C instantly rather than moving with the passage of time when switching between displaying the first end side of the content and displaying the second end side of the content.

In addition, the distance between the first end and the second end of the content may be set to zero. In this case, it is preferable that the ends of the content are easy to recognize by emphasizing the display of the ends of the content such as by changing the color of a line in which the first end and the second end of the content overlap.

In addition, even if the content is of a size that fits within the screen of the touch panel, the content C may be set as a target object of the looped display. For example, the invention may be applied to display in a specific region, which is a region of a portion within the screen such as a window or a drop-down list box. In this case, in step with movement of the operator, display is performed so that a new image appears from an end section of the specific region as the operator moves rather than performing display so that a new image appears from the end section of the screen. In addition, the content C that is the target object of the looped display is not limited to a list, and may be any kind of content such as photograph images, chart pages, or text pages.

In addition, the movement direction of the content in the looped display may be the long side direction of the screen, may be a short side direction, or may be all directions including diagonal directions. In addition, the follow amount of the content, which corresponds to the operator during a period in which the ends of the content are being displayed may coincide with the follow amount during a period in which the ends of the content C are not being displayed, or may be higher than the follow amount during a period in which the ends of the content are not being displayed. The follow amount may be changed dynamically such as the follow amount of the content, which corresponds to the operator during a period in which the ends of the content are being displayed being separated from the follow amount during a period in which the ends of the content C are not being displayed by an amount by which the ends of the content C are separated from the end sections of the screen.

In addition, a configuration in which the follow amounts may be merely set so that the follow amounts at the end section of the content differ from a central section in the abovementioned manner without changing the display when a finger becomes separated, may be used. Alternatively, a configuration in which the follow amount is normally fixed, and the display is changed in the abovementioned manner when a finger becomes separated, may be used.

In addition, the first end and the second end may be fixed together and not look like end sections, or the first end and the second end may be separated, and a special image for showing the background of the content or space may be displayed in the area therebetween.

In addition, the touch display may be a device that displays images in air using a hologram method.

1. A display system comprising:
a touch display configured to display a content and to detect a movement of an operator, the content including a first region with a first end of the content, a second region with a second end of the content, a third region and a fourth region disposed between the first region and the second region; and
a control unit configured to control displaying of the content on the touch display based on the movement of the operator detected by the touch display
wherein, when the touch display detects that the operator is moving in a first direction with respect to the touch display, the control unit is configured to
move the content displayed on the touch display to follow the movement of the operator so that the fourth region of the content is displayed on the touch display, in a first case in which the third region of the content is being displayed on the touch display when the operator starts moving in the first direction, and
move the content displayed on the touch display to follow the movement of the operator so that the first region and the second region of the content are displayed on the touch display, in a second case in which the first region is being displayed when the operator starts moving in the first direction, and
a follow amount in the first case differs from a follow amount in the second case.

2. The display system according to claim 1,
the control unit is further configured to move the content displayed on the touch display to follow the movement of the operator so that display of the first region is ceased while the second region is displayed, in a third case in which the first region and the second region are being displayed when the operator starts moving in the first direction.

3. The display system according to claim 2, wherein
when the operator becomes separated from the touch display in the third case, the control unit is configured to switch between a first display mode and a second display mode depending on a separation timing at which the operator becomes separated from the touch display,
the first region is displayed and the second region is not displayed on the touch display in the first display mode, and
the second region is displayed and the first region is not displayed on the touch display in the second display mode.

4. The display system according to claim 3, wherein
the control unit is configured to move the content displayed on the touch display to follow the movement of the operator so that the second region appears on the touch display from a second direction opposite to the first direction in the second case, and
when the operator becomes separated from the touch display in the third case, the control unit is configured to switch between the first display mode, in which the first region and the second region are moved in the second direction so that the display of the second region is ceased while the first region is displayed on the touch display, and the second display mode, in which the first region and the second region are moved in the first direction so that display of the first region is ceased while the second region is displayed on the touch display, depending on the separation timing.

5. The display system according to claim 4, wherein
when the operator becomes separated from the touch display in the third case, the control unit is configured to switch to the first display mode when a distance that the operator has moved in the first direction before the separation timing since the first end of the content has appeared on the touch display is equal to or smaller than a threshold value, and
the control unit is configured to switch to the second display mode when the distance that the operator has moved in the first direction before the separation timing since the first end of the content has appeared on the touch display is greater than the threshold value.

6. The display system according to claim 1, wherein
the control unit is configured to display an image other than the content between the first region and the second region when the first region and the second region are being displayed at the same time.

7. The display system according to claim 1, wherein
the control unit is configured to display the first region further toward the first direction than the second end of the content, and display the second region further toward a second direction opposite to the first direction than the first end of the content when the first region and the second region are being displayed at the same time.

8. The display system according to claim 1, wherein
the follow amount in the second case is lower than the follow amount in the first case.

9. The display system according to claim 1, wherein
a difference between the follow amount in the second case and the follow amount in the first case becomes larger according to an amount by which the first end or the second end is separated from an end of a display region of the touch display within which the content is displayed in the second case.

10. The display system according to claim 1, wherein
the first end is an end that is on an side of the content opposite to the first direction, and
the second end is an end of the content in the first direction.

11. The display system according to claim 1, wherein
the control unit is configured to perform looped display, which loops display of the content in the first direction.

12. A display system comprising:
a touch display configured to display a content and to detect a movement of an operator, the content including a first region with a first end of the content, a second region with a second end of the content, a third region and a fourth region disposed between the first region and the second region; and
a control unit configured to control displaying of the content on the touch display based on the movement of the operator detected by the touch display
wherein, when the touch display detects that the operator is moving in a first direction with respect to the touch display, the control unit is configured to
move the content displayed on the touch display to follow the movement of the operator so that the fourth region of the content is displayed on the touch display, in a first case in which the third region of the content is being displayed on the touch display when the operator starts moving in the first direction,
move the content displayed on the touch display to follow the movement of the operator so that the first region and the second region of the content are displayed on the touch display, in a second case in which the first region is being displayed when the operator starts moving in the first direction, and
move the content displayed on the touch display to follow the movement of the operator so that display of the first region is ceased while the second region is displayed, in a third case in which the first region and the second region are being displayed when the operator starts moving in the first direction, and
when the operator becomes separated from the touch display in the third case, the control unit is configured to display one of the first region and the second region, and not display the other of the first region and the second region depending a separation timing at which the operator becomes separated from the touch display.

13. A non-volatile storage medium storing a program having a function of displaying a content on a touch display so as to follow a movement of an operator detected by the touch display, the content including a first region with a first end of the content, a second region with a second end of the content, a third region and a fourth region disposed between the first region and the second region, the non-volatile storage medium storing the program causing a computer to execute the functions of:
when the touch display detects that that the operator is moving in a first direction with respect to the touch display,
moving the content displayed on the touch display to follow the movement of the operator so that the fourth region of the content is displayed on the touch display, in a first case in which the third region of the content is being displayed on the touch display when the operator starts moving in the first direction; and
moving the content displayed on the touch display to follow the movement of the operator so that the first region and the second region of the content are displayed on the touch display, in a second case in which the first region is being displayed when the operator starts moving in the first direction, wherein
a follow amount in the first case differs from a follow amount in the second case.
